(19) United States
(12) Patent Application Publication
(10) Pub. No.: US 2022/0005229 A1
(43) Pub. Date: Jan. 6, 2022

(54) POINT CLOUD ATTRIBUTE ENCODING METHOD AND DEVICE, AND POINT CLOUD ATTRIBUTE DECODING METHOD AND DEVCIE

(71) Applicants: SZ DJI TECHNOLOGY CO., LTD., Shenzhen (CN); ZHEJIANG UNIVERSITY, Hangzhou (CN)

(72) Inventors: Pu LI, Shenzhen (CN); Xiaozhen ZHENG, Shenzhen (CN); Jiafeng CHEN, Hangzhou (CN); Wenyi WANG, Hangzhou (CN); Lu YU, Hangzhou (CN)

(21) Appl. No.: 17/479,812

(22) Filed: Sep. 20, 2021

Related U.S. Application Data
(63) Continuation of application No. PCT/CN2019/079150, filed on Mar. 21, 2019.

(51) Int. Cl. G06T 9/00

(52) U.S. Cl. CPC G06T 9/00

(57) ABSTRACT

A point cloud attribute encoding method includes performing binarization on an attribute value in point cloud data to obtain a binary attribute value, and performing arithmetic encoding on bits in the binary attribute value using at least one probability model. A bit depth of the binary attribute value is larger than or equal to 1.

### CROSS-REFERENCE TO RELATED APPLICATION

This application is a continuation of International Application No. PCT/CN2019/079150, filed Mar. 21, 2019, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data processing technologies and, more particularly, to a point attribute encoding method and device, and a point attribute decoding method and device.

### BACKGROUND

A point cloud is a form of expression of a three-dimensional object or a three-dimensional scene, and includes a set of discrete points that are randomly distributed in space and express the spatial structure and surface properties of the three-dimensional object or the three-dimensional scene. To reduce the bandwidth occupied by storage or transmission of point cloud data, it is needed to encode and compress the point cloud data. The point cloud data usually includes position information and attribute information. The position information is used to describe the position of the point cloud data, such as three-dimensional coordinates. The attribute information is used to describe attributes of the point cloud data, such as color or reflectivity.

In the process of encoding and compressing a point cloud, the processing of position information is usually carried out separately from the processing of attribute information. The processing process of the position information includes: quantizing coordinates; removing duplicate coordinates in the coordinates; performing octree encoding on the processed coordinates; and reordering the attribute information according to the order of the coordinates after the octree encoding, and generating a hierarchical encoding scheme. The processing process of the attribute information includes: performing attribute conversion on the attribute information, for example, converting from RGB format to YCbCr format; performing predictive encoding on the attribute information after attribute conversion according to the hierarchical coding scheme to generate residuals, and quantizing the residuals. Finally, arithmetic encoding is performed on the octree-encoded position information and the quantized residual error to generate a code stream.

The foregoing encoding process needs to traverse all or part of the point cloud data multiple times, which incurs relatively large time overhead. The decoding process is roughly the same as the reverse process of the encoding process, and there is also the problem of large time overhead.

### SUMMARY

In accordance with the disclosure, there is provided a point cloud attribute encoding method including performing binarization on an attribute value in point cloud data to obtain a binary attribute value, and performing arithmetic encoding on bits in the binary attribute value using at least one probability model. A bit depth of the binary attribute value is larger than or equal to 1.

In accordance with the disclosure, there is also provided a point cloud attribute decoding method including performing arithmetic decoding on attribute information in a code stream using at least one probability model to obtain a binary attribute value, and performing inverse binarization on the binary attribute value according to a binarization method corresponding to the binary attribute value to obtain an attribute value.

In accordance with the disclosure, there is also provided a point cloud attribute decoding device including a memory storing codes, and a processor configured to execute the codes to perform arithmetic decoding on attribute information in a code stream using at least one probability model to obtain a binary attribute value, and perform inverse binarization on the binary attribute value according to a binarization method corresponding to the binary attribute value to obtain an attribute value.

### BRIEF DESCRIPTION OF THE DRAWINGS

FIG. 1 is a schematic flow chart of an encoding method consistent with the present disclosure.

FIG. 2 is a schematic flow chart of a decoding method consistent with the present disclosure.

FIG. 3 is a schematic flow chart of a point cloud attribute encoding method consistent with the present disclosure.

FIG. 4 is a schematic flow chart of a point cloud attribute decoding method consistent with the present disclosure.

FIG. 5 is a schematic block diagram of an encoding device consistent with the present disclosure.

FIG. 6 is a schematic block diagram of a decoding device consistent with the present disclosure.

### DETAILED DESCRIPTION OF THE EMBODIMENTS

The technical solutions in the embodiments of the present disclosure will be described below in conjunction with the drawings in the embodiments of the present disclosure. Obviously, the described embodiments are some of the embodiments of the present disclosure, but not all of the embodiments. Based on the embodiments in this disclosure, all other embodiments obtained by those of ordinary skill in the art without creative work shall fall within the scope of this disclosure.

Unless otherwise specified, all technical and scientific terms used in the embodiments of the present disclosure have the same meaning as commonly understood by those skilled in the technical field of the present application. The terms used in this disclosure are only for the purpose of describing specific embodiments, and are not intended to limit the scope of this application.

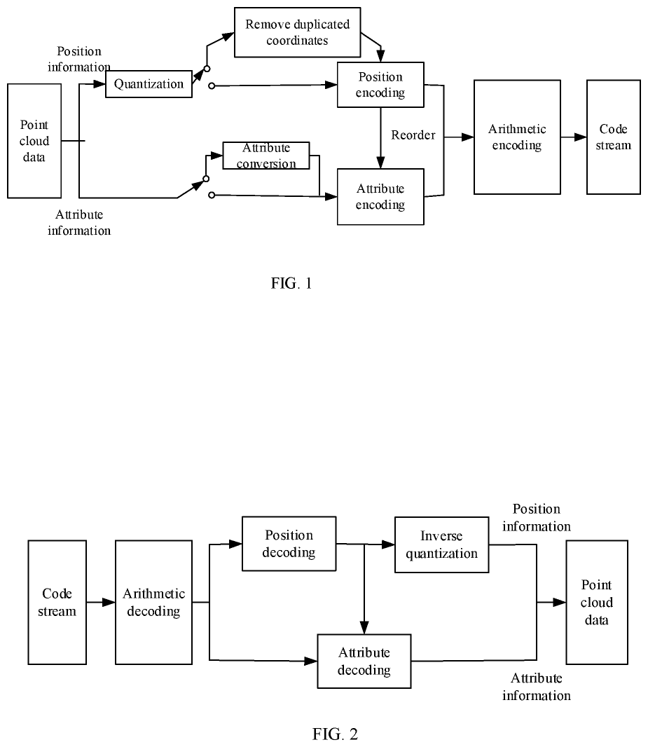

FIG. 1 is a schematic flow chart of an encoding method consistent with the present disclosure.

An encoding system may encode position information and attribute information in input point cloud data. The point cloud data may be point cloud data captured by a sensor (for example, a laser radar) at a mobile platform.

In one embodiment, for the position information, the position information may be quantized. For example, coordinate values may be rounded. Duplicate coordinates may be removed first in the quantized coordinates and then position encoding may be performed, or position encoding may be directly performed on the quantized coordinates. The position encoding described above may be, for example, octree encoding. The order of the position information after position encoding may change.

For the attribute information, the attribute information can be encoded after attribute conversion, or the attribute information can be directly encoded. If the process of removing duplicate coordinates is performed, the attribute conversion may need to be performed during the attribute encoding process. For example, the attribute information corresponding to the merged coordinates may be merged. If the process of removing duplicate coordinates is not performed, the attribute information can be directly encoded. Subsequently, the attribute information may be encoded in sequence according to the order of the position information. The above attribute encoding may be, for example, binarizing the attribute information, that is, converting the value of the attribute information into binary code.

Subsequently, arithmetic encoding (i.e., compression encoding) may be performed on the position information after the position encoding and the attribute information after the attribute encoding in an arithmetic encoding engine, to obtain a code stream after compression encoding.

The decoding process of point cloud data is roughly the same as a reverse process of the encoding process. FIG. 2 is a schematic flow chart of a decoding method consistent with the present disclosure.

After obtaining an input code stream, a decoding system may first perform arithmetic decoding to obtain position information to be decoded and attribute information to be decoded. The decoding system may decode the position information to be decoded and the attribute information to be decoded.

The decoding system may first perform position decoding to obtain quantized position information, and then perform inverse quantization processing on the quantized position information to obtain position information.

After obtaining the quantized position information, the decoding system can perform attribute decoding in an order of the quantized position information. For example, the attribute information to be decoded may be decoded to obtain binary code containing the attribute information, and then the binary code may be decoded according to a binarization method used by the encoding system to obtain the attribute information. Specifically, the decoding system may determine the binarization method used by the encoding system according to indication information in header information of the code stream, or may determine the binarization method used by the encoding system according to preset information in the decoding system.

Finally, the point cloud data can be obtained by combining the position information and attribute information obtained by the above decoding.

In the encoding system provided by the present disclosure, the attribute information may be processed through the binarization method without generating a hierarchical encoding scheme, that is, it may be not necessary to traverse all or part of the point cloud data multiple times, thereby reducing the time overhead in the encoding process. Similarly, in the decoding system provided by the present disclosure, the attribute information may be reconstructed through the inverse process of the binarization method. There may be no need to reconstruct the attribute information based on the hierarchical encoding scheme, that is, there may be no need to traverse all or part of the point cloud data multiple times, thereby reducing time overhead in the decoding process.

Processes for encoding and decoding based on the binarization method provided by the present disclosure will be described below.

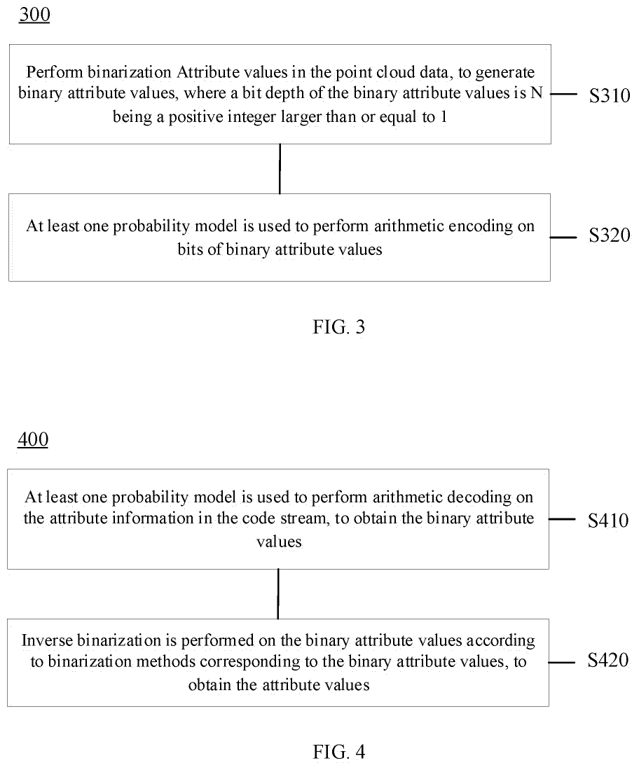

FIG. 3 is a schematic flow chart of a point cloud attribute encoding method consistent with the present disclosure. As shown in FIG. 3, the method 300 includes S310 to S320.

At S310, attribute values in the point cloud data are binarized, to generate binary attribute values. Specifically, a bit depth of the binary attribute values may be N where N is a positive integer larger than or equal to 1.

The attribute values may be the attribute information described above. For example, the attribute values may be reflectivity. The attribute values can be values obtained after attribute conversion, or values that have not undergone attribute conversion. Binarization may be a process to convert non-binary values into binary values.

The encoding system may select a target binarization method according to actual situations. For example, when the decoding system only supports fixed-length codes, the encoding system may select a fixed-length code encoding method as the target binarization method. When the decoding system supports the fixed-length code encoding, truncated Rice code encoding, and exponential Columbus code, the encoding system may choose a binarization method with better encoding performance as the target binarization method. It should be noted that the above three methods are only examples, and the binarization method applicable to the present disclosure is not limited here.

In one embodiment, the encoding system and the decoding system may use the same binarization method by default, and the encoding system may not need to indicate in the code stream which binarization method the encoding system uses.

In another embodiment, the encoding system and the decoding system may not agree on which binarization method to use, and the encoding system may need to indicate which binarization method is used in the encoded stream. In one embodiment, the header information of the code stream may include second indication information, and different values of the second indication information may be used to indicate different types of binary attribute values. For example, the second indication information may be used to indicate that the binary attribute values are fixed-length code, or that the binary attribute values are truncated Rice code, or that the binary attribute values are exponential Columbus code.

The method 300 in the present embodiment of the present disclosure may perform binarization on the attribute information in the cloud point data and then perform arithmetic encoding on the binarization results, to avoid encoding and/or decoding the attribute information using the hierarchical encoding scheme. The time overhead may be reduced.

The binarization process will be described by using three situations as examples.

In the first situation, the target binarization method may be the fixed-length code encoding method.

The fixed-length code encoding method may be a method of converting attribute values into fixed-length binary codes. The fixed length may be a number of bits contained in the binary code, and can also be called bit depth. The bit depth N may be a positive integer larger than or equal to 1. For example, N can be equal to 8 or 10 or 12. In one embodiment, the bit depth N can be written into the header information of the arithmetic-encoded code stream for use by the decoder.

In the second situation, the target binarization method may be the truncated Rice code encoding method.

Binarization of the attribute values may use the truncated Rice code encoding method. The threshold value is cMax, the Rice parameter is R, and the attribute value is Ref. The truncated Rice code may be formed by concatenating a prefix code and a suffix code. The prefix value P may be calculated as shown in Equation 1:

P=Ref>>R, (Equation 1)

where “>>” represents a right shift operation. When P is less than the value (cMax>>R), the prefix code may include P 1s (i.e., the number of is in the prefix code may be P) and one 0, and the length may be P+1. When P is larger than or equal to the value (cMax>>R), the prefix code may include (cMax>>R) is (i.e., the number of is in the prefix code may be (cMax>>R)) and the length may be (cMax>>R). When the attribute value Ref is less than cMax, the suffix value S of Ref may be calculated as shown in Equation 2:

S=Ref−(P<<R), (Equation 2)

where “<<” represents a left shift operation. The suffix code may be a binarized string of S, and the length may be R. When the attribute value Ref is larger than or equal to cMax, there may be no suffix code. Then the binary code stream after the attribute value binarization may be sequentially sent to the arithmetic encoding engine in the order of the position information after the position encoding for compression encoding, to obtain the compressed code stream finally. Regarding the cut-off Rice threshold cMax, the Rice parameter R can be set.

In one embodiment, the threshold value of the truncated Rice code and/or the Rice parameter may be written into the header information of the arithmetic-encoded code stream for use by the decoder.

In the third situation, the target binarization method may be the exponential Columbus code encoding method.

Binarization of the attribute values may use the exponential Columbus code encoding method. The exponential Columbus code may include a prefix and a suffix. Both the prefix and the suffix may depend on the order k of the exponential Columbus code. The kth-order exponential Columbus code representing the non-negative integer attribute N can be generated by:

(1) writing the number X in binary form, removing the lowest k bits, and adding 1 afterward;

(2) calculating the number of bits left and subtracting one from this number, to obtain the number of prefix zeros that need to be added;

(3) adding the lowest k bits removed in (1) to the end of the bit string.

For example, a reflectivity value (that is, an attribute value) is 4, and then a first order exponential Columbus code encoding method may include the following.

(1) A binary form of 4 is 100, and it changes to 10 after the lowest 1 bit is removed and then changes to 11 after 1 is added.

(2) A bit number of 11 is 2, and thus a number of 0 in the prefix is 1.

(3) 0, which is removed in (1), is added to the end of the bit string and the final code is obtained as 0110.

For the kth-order Columbus code, the prefix may include m consecutive 0s and one 1, and the suffix may include m+k, which is the binary representation of X−2k(2m−1). Based on this, the binarization of attributes can be realized. Then, the binary code stream after attribute binarization may be sequentially sent to the arithmetic encoding engine in the order of the position information after position encoding for compression encoding, and finally the compressed code stream may be obtained. Optionally, the order of the Columbus code may be included in the header information of the code stream. Optionally, the order of the Columbus code may also be information preset by the encoding system and the decoding system. In this case, the header information of the code stream may not need to include the order of the Columbus code.

For description purposes only, the embodiments with the above three binarization methods are used as examples to illustrate the present disclosure and do not limit the scope of the present disclosure. The header information of the code stream generated finally by the encoding system may include indication information indicating the binarization method.

After the binarization of the attribute values, the encoding system may use a probability model for the arithmetic encoding of a binary attribute value. For one binary attribute value, it may include N bits, where N is a positive integer larger than or equal to 1, and the encoding system may perform S320 to perform arithmetic encoding on it.

At S320, at least one probability model is used to perform arithmetic encoding on bits of one binary attribute value.

In one embodiment, when at least two probability models are used for arithmetic coding, the header information of the code stream finally generated by the encoding system may include indication information indicating that the encoding end uses multiple (i.e., at least two) probability models for arithmetic encoding.

The basic principle of arithmetic encoding may include: according to the probability of different symbol sequences that the source may find, the interval [0, 1) is divided into non-overlapping sub-intervals, where the width of each sub-interval is the probability of a corresponding symbol sequence. In this way, the different symbol sequences sent by the source will correspond to various sub-intervals one-to-one. Correspondingly, any real number in each sub-interval can be used to represent one corresponding symbol sequence, and this number is the code word corresponding to the symbol sequence. Obviously, when the probability of one symbol sequence is larger, the corresponding sub-interval is wider, the number of bits used to express it is less, and the corresponding code word is shorter.

The binary attribute value may be a symbol sequence, and the probability that one bit value appears on each of the N bits can be described by a probability model.

In one embodiment, all bits in the binary attribute value may be arithmetically encoded using the same probability model. Optionally, after each one or more bits are encoded, the same probability model may be updated, and the next one or more bits may be arithmetically encoded using the updated probability model.

In some other embodiments, at least two probability models may be used to respectively perform arithmetic encoding on different bits in the binary attribute value. For example, among the N bits of the binary attribute value, the first N/2 bits may be arithmetically encoded using a first probability model, and the last N/2 bits may be arithmetically encoded using a second probability model. Optionally, after every one or more bits of the first N/2 bits are encoded, the first probability model may be updated, and the updated first probability model may be used for performing arithmetic encoding on next one or more bits. After every one or more bits of the last N/2 bits are encoded, the second probability model may be updated, and the updated second probability model may be used for performing arithmetic encoding on next one or more bits.

For the N bits of the binary attribute value, M probability models can be used to determine the probability of the bit value of each bit, where N and M are both positive integers larger than or equal to 1, and M is less than or equal to N.

In one embodiment, one same probability model may be used to perform arithmetic decoding on at least the lowest 2 bits in the binary attribute value. In some other embodiments, arithmetic decoding may be performed on the highest at least 2 bits in the binary attribute value using different probability models.

In one embodiment, a bit-by-bit encoding method can be adopted, that is, different bits of the binary attribute value may be arithmetically encoded using different probability models. Specifically, N probability models may be used to perform arithmetic encoding on N bits.

In one embodiment, for different binary attribute values, the same probability model may be used to perform arithmetic encoding on the same bits. For example, for bits at the same position in each binary attribute value (for example, the second bits, or the second and third bits), the same probability model may be used for arithmetic encoding. Optionally, after each bit at one position of one or more binary attribute values is encoded, the corresponding probability model may be updated, and then the updated probability model may be used to perform arithmetic encoding on the bit at this position in next one or more binary attribute values.

The encoding system can determine the probability model corresponding to one bit according to the bit. For example, when the N bits of the binary attribute value include the first part of the bits, the encoding system can determine the first probability model corresponding to the first part of the bits from the M probability models, and use the first probability model to encode the first part of the bits. When the N bits of the binary attribute value include the second part of the bits, the encoding system can determine the second probability model corresponding to the second part of the bits from the M probability models, and use the second probability model to encode the second part of the bits.

A same bit value may appear in different bit positions with different probabilities. Compared to the method in the existing technologies that use only one probability model to perform arithmetic encoding on the binary attribute value, the arithmetic encoding method provided in the present disclosure may use at least two probability models to perform arithmetic encoding on the binary attribute value, such that the probability of bit values on different bits can be determined more accurately.

Optionally, the encoding system may also use the same probability model to encode multiple bits. For example, the first part of bits may include at least two bits, the first probability model may be one probability model, and the encoding system can use the one probability model to encode the at least two bits, thereby reducing the complexity of arithmetic encoding.

For one binary attribute value, because the probability of different bit values on the low-order bits is the same or similar, the encoding system can use a probability model to encode multiple low-order bits, which can reduce the complexity of arithmetic encoding and the impact of encoding accuracy of the arithmetic encoding. For high-order bits, different probability models can be used for arithmetic encoding.

For example, when the binary attribute value is 0100, the bits with the two “0”s on the right are low bits. One same probability model may be used to perform arithmetic encoding on these two bits. The bits with the “01” on the left are high bits, and different probability models may be used to encode these two bits.

The encoding system can also update the probability model corresponding to a bit according to the number of times that different bit values appear on the bit. For example, there are two bit values for the first bit, namely “0” and “1”. When the bit value of the first bit of the current binary attribute value is “0”, the encoding system can update the first probability model to increase the probability value of “0” and decrease the probability value of “1”. When the bit value of the first bit of the current binary attribute value is “1”, the encoding system can update the first probability model to increase the probability value of “1” and decrease the probability value of “0”.

The probability model described above can be referred to as a “context probability model,” which has the property of adaptive change. The probability model in various embodiments of the present disclosure may also be a fixed probability model, that is, the probability model that does not change with changes in context.

When the context probability model is used to perform arithmetic encoding on different bits of a binary attribute value, the encoding system can use the same initial probability model to perform arithmetic encoding on the different bits in the binary attribute value and update the probability models corresponding to the different bits of the binary attribute value respectively. The updated probability models may be used to perform arithmetic encoding on the corresponding bits.

In some embodiments, the encoding system can also use different initial probability models to perform arithmetic encoding on different bits in the binary attribute value, update the probability models corresponding to different bits in the binary attribute value, and then use the updated probability models to perform arithmetic encoding on different bits in the binary attribute value.

The encoding system can use the same update method to update the probability models corresponding to different bits in the binary attribute value respectively. In some embodiments, the encoding system may adopt different update methods to update the probability models corresponding to different bits in the binary attribute value respectively.

The different probability models mentioned above (such as the “first probability model” and “second probability model” mentioned above) can be obtained by updating the same initial probability model, or can be derived from different initial probability models by updating. In addition, the different probability models may be updated according to the same update method or different update methods.

In one embodiment, the code stream may further include first indication information, and the first indication information may be used to indicate the arithmetic encoding scheme of the binary attribute value.

Optionally, the first indication information may be used to indicate that the encoding scheme of the attribute value is a direct encoding scheme, and the direct coding scheme may include that using at least one probability model to perform arithmetic encoding after binarizing the attribute value. Optionally, in some other embodiments, the direct encoding scheme may include using a plurality of probability models to perform arithmetic encoding after binarizing the attribute value. For example, the direct encoding scheme may be the encoding scheme described in the method 300 provided above.

Optionally, different values of the first indication information may be respectively used to indicate different arithmetic encoding schemes. For example, the arithmetic encoding scheme may include at least one of a direct encoding scheme, a hierarchical encoding scheme, or a Morton code-based predictive encoding scheme. Different values of the first indication information may be respectively used to indicate different schemes.

In one embodiment, the code stream may not contain indication information for indicating the arithmetic encoding scheme of the binary attribute value, and the encoding and decoding ends may use the same arithmetic encoding scheme by default. For example, the direct encoding scheme may be adopted by default.

The encoding method provided by the present disclosure is described in detail above, and the decoding method is roughly same to the inverse process of the encoding method. For example, the encoding system binarizes the attribute value based on the fixed-length code encoding method, and the decoding system can decode the binary attribute value based on the fixed-length code decoding method. In another example, the encoding system uses different probability models to encode different bits of the binary attribute value, and the decoding system can use different probability models to decode different bits of the binary attribute value. Therefore, even if the processing procedures of the decoding system are not clearly stated in the above individual places, those skilled in the art can clearly understand the processing procedures of the decoding system based on the processing procedures of the encoding system.

FIG. 4 is a schematic flow chart of a point cloud attribute decoding method consistent with the present disclosure. As shown in FIG. 4, the method includes S410 and S420.

At S410, at least one probability model is used to perform arithmetic decoding on the attribute information in the code stream, to obtain the binary attribute values.

At S420, inverse binarization is performed on the binary attribute values according to binarization methods corresponding to the binary attribute values, to obtain the attribute values.

The decoding system may obtain the code stream first, and then use the at least one probability model to perform arithmetic decoding.

Optionally, S401 may include using at least two probability models to perform arithmetic decoding on different bits in the code stream.

Optionally, the method 400 may further include: for same bits in different binary attribute values in the code stream, using one same probability model to perform arithmetic decoding.

Optionally, S410 may include:

performing arithmetic decoding on the lowest 2 bits in the binary attribute value using the same probability model.

Optionally, S410 may include:

performing arithmetic decoding on the highest 2 bits in the binary attribute value using different probability models.

Optionally, S410 may include:

performing arithmetic decoding on different bits in a binary attribute value using different probability models.

Optionally, before S410, the method 400 may further include:

receiving the code stream including binary attribute values.

Optionally, the header information of the code stream may include first indication information, and the first indication information is used to indicate an arithmetic encoding scheme of the binary attribute value.

Optionally, different values of the first indication information may be respectively used to indicate different arithmetic encoding schemes.

Optionally, the first indication information may be used to indicate that the encoding scheme of the attribute value is a direct coding scheme, and the direct encoding scheme may include performing binarization on the attribute value and then using at least one probability model to perform arithmetic encoding.

Optionally, the direct encoding scheme may include performing arithmetic encoding using a plurality of probability models after binarizing the attribute value.

Optionally, the header information of the code stream may include second indication information, and different values of the second indication information may be used to indicate different types of the binary attribute values.

Optionally, the second indication information may be used to indicate that the binary attribute value is one of a fixed-length code, a truncated Rice code, or an exponential Columbus code.

Optionally, the second indication information may be used to indicate that the binary attribute value is a fixed-length code;

The header information of the code stream may further include third indication information which is used to indicate the bit depth of the fixed-length code.

Optionally, the second indication information may be used to indicate that the binary attribute value is a truncated Rice code.

The header information of the code stream may further include fourth indication information which is used to indicate the threshold value and/or the Rice parameter of the truncated Rice code.

Optionally, the second indication information may be used to indicate that the binary attribute value is an exponential Columbus code;

The header information of the code stream may further include fifth indication information which is used to indicate the order of the exponential Columbus code.

Optionally, the second indication information may be used to indicate that the binary attribute value is an exponential Columbus code.

The order of the exponential Columbus code may be a default value.

Optionally, the binary attribute value may be a fixed-length code by default, and the header information of the code stream may further include third indication information for indicating the bit depth of the fixed-length code.

Or the binary attribute value may be a truncated Rice code by default, and the header information of the code stream may further include fourth indication information for indicating the threshold value and/or Rice parameter of the truncated Rice code.

Or the binary attribute value may be the exponential Columbus code by default, and the order of the exponential Columbus code may be the default value, or the header information of the code stream may further include fifth indication information for indicating the order of the exponential Columbus code.

Optionally, the code stream may further include sixth indication information which is used to indicate that the same probability model or different probability models are used for different bits of the binary attribute value.

Optionally, the probability model may be a context probability model.

Optionally, the method 400 may further include updating the probability models according to the decoded bits.

Optionally, the attribute values may include reflectivity.

Optionally, the point cloud data may be point cloud data captured by a sensor at a mobile platform.

The above embodiments all have corresponding descriptions in the method 300.

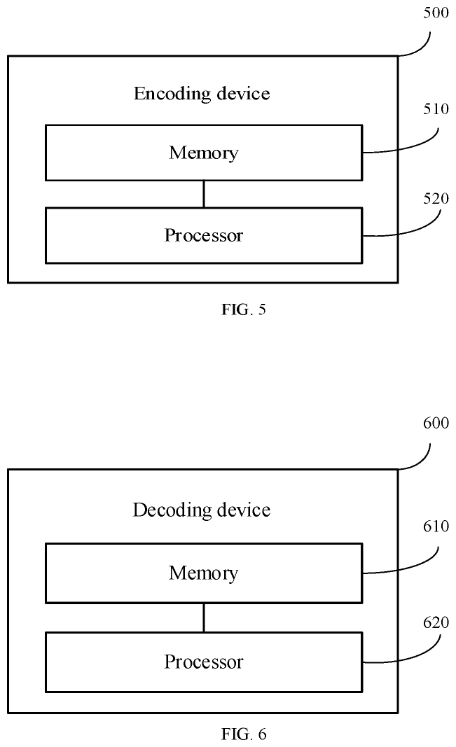

The methods provided by various embodiments have been described above using FIG. 1 to FIG. 4 as examples. Devices provided by various embodiments will be described below using FIG. 5 to FIG. 6 as examples. The devices provided by various embodiments and the methods provided by various embodiments correspond to each other. Therefore, the previous method embodiments can be referred to for the parts that are not described in detail below.

FIG. 5 is a schematic block diagram of an encoding device consistent with the present disclosure. As shown in FIG. 5, the device 500 includes a memory 510 and a processor 520.

The memory 510 is configured to store codes. The processor 520 is configured to access the codes in the memory 510 to execute: binarization of attribute values in point cloud data to obtain binary attribute values; and using at least one probability model to perform arithmetic encoding on bits in the binary attribute values. A bit depth of the binary attribute values may be N where N is a positive integer larger than or equal to 1.

Optionally, using the at least one probability model to perform arithmetic encoding on the bits in the binary attribute value may include: using at least two probability models to perform arithmetic encoding on different bits in the binary attribute values.

Optionally, the processor 520 may be further configured to perform arithmetic encoding using the same probability model for the same bits in different binary attribute values.

Optionally, using at least one probability model to perform arithmetic encoding on the bits in the binary attribute values may include: using the same probability model to perform arithmetic encoding on the lowest two bits in the binary attribute values.

Optionally, using at least one probability model to perform arithmetic encoding on the bits in the binary attribute value may include: using different probability models to perform arithmetic encoding on the highest two bits in the binary attribute values.

Optionally, using at least one probability model to perform arithmetic encoding on the bits in the binary attribute values may include: using different probability models to perform arithmetic encoding on different bits in the binary attribute values.

Optionally, the processor 520 may be further configured to: generate a code stream including the encoding result of the arithmetic coding.

Optionally, header information of the code stream may include first indication information, and the first indication information may be used to indicate an encoding scheme of the attribute values.

Optionally, different values of the first indication information may be respectively used to indicate different encoding schemes.

Optionally, the first indication information may be used to indicate that the encoding scheme of the attribute values is a direct encoding scheme, and the direct encoding scheme may include performing binarization of the attribute value and then using at least one probability model for arithmetic encoding.

Optionally, the direct encoding scheme may include performing binarization of the attribute value and then using a plurality of probability models for arithmetic encoding.

Optionally, the header information of the code stream may include second indication information, and different values of the second indication information may be used to indicate different types of the binary attribute values.

Optionally, the second indication information may be used to indicate that the binary attribute value is one of a fixed-length code, a truncated Rice code, or an exponential Columbus code.

Optionally, the second indication information may be used to indicate that the binary attribute value is a fixed-length code;

The header information of the code stream may further include third indication information which is used to indicate the bit depth of the fixed-length code.

Optionally, the second indication information may be used to indicate that the binary attribute value is a truncated Rice code;

The header information of the code stream may further include fourth indication information which is used to indicate the threshold value and/or the Rice parameter of the truncated Rice code.

Optionally, the second indication information may be used to indicate that the binary attribute value is an exponential Columbus code;

The header information of the code stream may further include fifth indication information which is used to indicate the order of the exponential Columbus code.

Optionally, the second indication information may be used to indicate that the binary attribute value is an exponential Columbus code.

The order of the exponential Columbus code may be a default value.

Optionally, the binary attribute value may be a fixed-length code by default, and the header information of the code stream may further include third indication information for indicating the bit depth of the fixed-length code.

Or the binary attribute value may be a truncated Rice code by default, and the header information of the code stream may further include fourth indication information for indicating the threshold value and/or Rice parameter of the truncated Rice code.

Or the binary attribute value may be the exponential Columbus code by default, and the order of the exponential Columbus code may be the default value, or the header information of the code stream may further include fifth indication information for indicating the order of the exponential Columbus code.

Optionally, the code stream may further include sixth indication information which is used to indicate that the same probability model or different probability models are used for different bits of the binary attribute value.

Optionally, the probability model may be a context probability model.

Optionally, the processor 520 may be further configured to update the probability models according to the decoded bits.

Optionally, using at least two probability models to perform arithmetic encoding on different bits in the binary attribute values may include: using different initial probability models to perform arithmetic encoding on different bits in the binary attribute values, updating the probability models corresponding to different bits in the binary attribute values respectively; and using the updated probability models to perform arithmetic encoding on the corresponding bits.

Optionally, updating the probability models corresponding to different bits in the binary attribute values respectively may include: using one same update method to update the probability models corresponding to different bits in the binary attribute values respectively.

Optionally, updating the probability models corresponding to different bits in the binary attribute values respectively may include: using different update methods to update the probability models corresponding to different bits in the binary attribute values respectively.

Optionally, the attribute values may include reflectivity.

Optionally, the point cloud data may be point cloud data captured by a sensor at a mobile platform.

In the present embodiment, the processor 520 may be further configured to access the codes in the memory 510 to execute: binarization of attribute values in point cloud data to obtain binary attribute values; and using at least one probability model to perform arithmetic encoding on bits in the binary attribute values where a bit depth of the binary attribute values may be N bits with N being a positive integer larger than or equal to 1 and the N bits include first part of bits; determining a first probability model corresponding to the first part of the bits from the M probability models where M is a positive integer larger than or equal to 1 and M is less than or equal to N; and using the first probability model to encode the first part of the bits.

Optionally, the first part of bits may include at least two bits.

Optionally, the first part of bits may be low-order bits of the binary attribute values.

Optionally, the first part of bits may be 1 bit.

Optionally, the value of the first part of bits may be the first part of bit values, and the processor 520 may be further configured to: update the first probability model according to the first part of bit values.

Optionally, the N bits may include a second part of bits; and the processor 520 may be further configured to use a second probability model to encode the second part of bits. The second probability model and the first probability model may be different.

Optionally, the value of the second part of bits is a second part of bit values, and the processor 520 may be further configured to update the second probability model according to the second part of bit values.

Optionally, the first probability model and the second probability model may be updated from same or different initial probability models.

Optionally, the first probability model and the second probability model may be updated using the same update method or different update methods.

Optionally, the processor 520 may be further configured to: generate a code stream including the encoding result of the arithmetic coding.

Optionally, header information of the code stream may include first indication information, and the first indication information may be used to indicate an encoding scheme of the attribute values.

Optionally, different values of the first indication information may be respectively used to indicate different encoding schemes.

Optionally, the first indication information may be used to indicate that the encoding scheme of the attribute values is a direct encoding scheme, and the direct encoding scheme may include performing binarization of the attribute value and then using at least one probability model for arithmetic encoding.

Optionally, the direct encoding scheme may include performing binarization of the attribute value and then using a plurality of probability models for arithmetic encoding.

Optionally, the header information of the code stream may include second indication information, and different values of the second indication information may be used to indicate different types of the binary attribute values.

Optionally, the second indication information may be used to indicate that the binary attribute value is one of a fixed-length code, a truncated Rice code, or an exponential Columbus code.

Optionally, the second indication information may be used to indicate that the binary attribute value is a fixed-length code;

The header information of the code stream may further include third indication information which is used to indicate the bit depth of the fixed-length code.

Optionally, the second indication information may be used to indicate that the binary attribute value is a truncated Rice code;

The header information of the code stream may further include fourth indication information which is used to indicate the threshold value and/or the Rice parameter of the truncated Rice code.

Optionally, the second indication information may be used to indicate that the binary attribute value is an exponential Columbus code;

The header information of the code stream may further include fifth indication information which is used to indicate the order of the exponential Columbus code.

Optionally, the second indication information may be used to indicate that the binary attribute value is an exponential Columbus code.

The order of the exponential Columbus code may be a default value.

Optionally, the binary attribute value may be a fixed-length code by default, and the header information of the code stream may further include third indication information for indicating the bit depth of the fixed-length code.

Or the binary attribute value may be a truncated Rice code by default, and the header information of the code stream may further include fourth indication information for indicating the threshold value and/or Rice parameter of the truncated Rice code.

Or the binary attribute value may be the exponential Columbus code by default, and the order of the exponential Columbus code may be the default value, or the header information of the code stream may further include fifth indication information for indicating the order of the exponential Columbus code.

Optionally, the code stream may further include sixth indication information which is used to indicate that the same probability model or different probability models are used for different bits of the binary attribute value.

Optionally, the probability model may be a context probability model.

Optionally, the attribute values may include reflectivity.

Optionally, the point cloud data may be point cloud data captured by a sensor at a mobile platform.

FIG. 6 is a schematic block diagram of a decoding device consistent with the present disclosure. As shown in FIG. 6, the device 600 includes a memory 610 and a processor 620.

The memory 610 is configured to store codes. The processor 620 is configured to access the codes in the memory 610 to execute: using at least one probability model to perform arithmetic decoding on attribute information in a code stream to obtain binary attribute values; and performing inverse binarization on the binary attribute values to obtain attribute values according to binarization methods corresponding to the binary attribute values.

Optionally, using the at least one probability model to perform arithmetic decoding on the bits in the code stream may include: using at least two probability models to perform arithmetic decoding on different bits in the code stream.

Optionally, the processor 620 may be further configured to perform arithmetic decoding using the same probability model for the same bits in different binary attribute values in the code stream.

Optionally, using the at least one probability model to perform arithmetic decoding on the bits in the code stream may include: using the same probability model to perform arithmetic decoding on the lowest two bits in the binary attribute values.

Optionally, using the at least one probability model to perform arithmetic decoding on the bits in the code stream may include: using different probability models to perform arithmetic decoding on the highest two bits in the binary attribute values.

Optionally, using the at least one probability model to perform arithmetic decoding on the bits in the code stream may include: using different probability models to perform arithmetic decoding on different bits in the binary attribute values.

Optionally, the processor 620 may be further configured to: receiving the code stream including the attribute information.

Optionally, header information of the code stream may include first indication information, and the first indication information may be used to indicate a decoding scheme of the attribute values.

Optionally, different values of the first indication information may be respectively used to indicate different decoding schemes.

Optionally, the first indication information may be used to indicate that the decoding scheme of the attribute values is a direct decoding scheme, and the direct encoding scheme may include performing binarization of the attribute value and then using at least one probability model for arithmetic decoding.

Optionally, the direct decoding scheme may include performing binarization of the attribute value and then using a plurality of probability models for arithmetic decoding.

Optionally, the header information of the code stream may include second indication information, and different values of the second indication information may be used to indicate different types of the binary attribute values.

Optionally, the second indication information may be used to indicate that the binary attribute value is one of a fixed-length code, a truncated Rice code, or an exponential Columbus code.

Optionally, the second indication information may be used to indicate that the binary attribute value is a fixed-length code;

The header information of the code stream may further include third indication information which is used to indicate the bit depth of the fixed-length code.

Optionally, the second indication information may be used to indicate that the binary attribute value is a truncated Rice code;

The header information of the code stream may further include fourth indication information which is used to indicate the threshold value and/or the Rice parameter of the truncated Rice code.

Optionally, the second indication information may be used to indicate that the binary attribute value is an exponential Columbus code;

The header information of the code stream may further include fifth indication information which is used to indicate the order of the exponential Columbus code.

Optionally, the second indication information may be used to indicate that the binary attribute value is an exponential Columbus code.

The order of the exponential Columbus code may be a default value.

Optionally, the binary attribute value may be a fixed-length code by default, and the header information of the code stream may further include third indication information for indicating the bit depth of the fixed-length code.

Or the binary attribute value may be a truncated Rice code by default, and the header information of the code stream may further include fourth indication information for indicating the threshold value and/or Rice parameter of the truncated Rice code.

Or the binary attribute value may be the exponential Columbus code by default, and the order of the exponential Columbus code may be the default value, or the header information of the code stream may further include fifth indication information for indicating the order of the exponential Columbus code.

Optionally, the code stream may further include sixth indication information which is used to indicate that the same probability model or different probability models are used for different bits of the binary attribute value.

Optionally, the probability model may be a context probability model.

Optionally, the processor 620 may be further configured to update the probability models according to the decoded bits.

Optionally, using at least two probability models to perform arithmetic decoding on different bits in the binary attribute values may include: using different initial probability models to perform arithmetic decoding on different bits in the binary attribute values, updating the probability models corresponding to different bits in the binary attribute values respectively; and using the updated probability models to perform arithmetic decoding on the corresponding bits.

Optionally, updating the probability models corresponding to different bits in the binary attribute values respectively may include: using one same update method to update the probability models corresponding to different bits in the binary attribute values respectively.

Optionally, updating the probability models corresponding to different bits in the binary attribute values respectively may include: using different update methods to update the probability models corresponding to different bits in the binary attribute values respectively.

Optionally, the attribute values may include reflectivity.

Optionally, the point cloud data may be point cloud data captured by a sensor at a mobile platform.

In the present embodiment, the processor 620 may be further configured to access the codes in the memory 610 to execute: performing arithmetic decoding on the attribute information in the code stream to obtain the binary attribute values; and performing inverse binarization on the binary attribute values to obtain the attribute values according to binarization methods corresponding to the binary attribute values. A bit depth of the binary attribute values may be N bits with N being a positive integer larger than or equal to 1 and the N bits include first part of bits. The first part of bits may be obtained by decoding using a first probability model and the first probability mode may be determined from M probability models where M is a positive integer larger than or equal to 1 and M is less than or equal to N.

Optionally, the first part of bits may include at least two bits.

Optionally, the first part of bits may be low-order bits of the binary attribute values.

Optionally, the first part of bits may be 1 bit.

Optionally, the value of the first part of bits may be the first part of bit values, and the processor 620 may be further configured to: update the first probability model according to the first part of bit values.

Optionally, the N bits may include a second part of bits. The second part of bits may be obtained by decoding using a second probability model. The second probability model and the first probability model may be different.

Optionally, the value of the second part of bits is a second part of bit values, and the processor 620 may be further configured to update the second probability model according to the second part of bit values.

Optionally, the first probability model and the second probability model may be updated from same or different initial probability models.

Optionally, the first probability model and the second probability model may be updated using the same update method or different update methods.

Optionally, the processor 620 may be further configured to: receiving the code stream including the attribute information.

Optionally, header information of the code stream may include first indication information, and the first indication information may be used to indicate a decoding scheme of the attribute values.

Optionally, different values of the first indication information may be respectively used to indicate different decoding schemes.

Optionally, the first indication information may be used to indicate that the decoding scheme of the attribute values is a direct decoding scheme, and the direct encoding scheme may include performing binarization of the attribute value and then using at least one probability model for arithmetic decoding.

Optionally, the direct decoding scheme may include performing binarization of the attribute value and then using a plurality of probability models for arithmetic decoding.

Optionally, the header information of the code stream may include second indication information, and different values of the second indication information may be used to indicate different types of the binary attribute values.

Optionally, the second indication information may be used to indicate that the binary attribute value is one of a fixed-length code, a truncated Rice code, or an exponential Columbus code.

Optionally, the second indication information may be used to indicate that the binary attribute value is a fixed-length code;

The header information of the code stream may further include third indication information which is used to indicate the bit depth of the fixed-length code.

Optionally, the second indication information may be used to indicate that the binary attribute value is a truncated Rice code;

The header information of the code stream may further include fourth indication information which is used to indicate the threshold value and/or the Rice parameter of the truncated Rice code.

Optionally, the second indication information may be used to indicate that the binary attribute value is an exponential Columbus code;

The header information of the code stream may further include fifth indication information which is used to indicate the order of the exponential Columbus code.

Optionally, the second indication information may be used to indicate that the binary attribute value is an exponential Columbus code.

The order of the exponential Columbus code may be a default value.

Optionally, the binary attribute value may be a fixed-length code by default, and the header information of the code stream may further include third indication information for indicating the bit depth of the fixed-length code.

Or the binary attribute value may be a truncated Rice code by default, and the header information of the code stream may further include fourth indication information for indicating the threshold value and/or Rice parameter of the truncated Rice code.

Or the binary attribute value may be the exponential Columbus code by default, and the order of the exponential Columbus code may be the default value, or the header information of the code stream may further include fifth indication information for indicating the order of the exponential Columbus code.

Optionally, the code stream may further include sixth indication information which is used to indicate that the same probability model or different probability models are used for different bits of the binary attribute value.

Optionally, the probability model may be a context probability model.

Optionally, the attribute values may include reflectivity.

Optionally, the point cloud data may be point cloud data captured by a sensor at a mobile platform.

The units and algorithm steps described in the embodiments disclosed herein can be implemented by hardware, software, firmware, or any combination thereof. When the embodiments in the present disclosure are implemented by software, it can be implemented in the form of a computer program product in whole or in part. The computer program product can include one or more computer instructions. When the computer program instructions are loaded and executed on the computer, the processes or functions described in the embodiments of the present disclosure are generated in whole or in part. The computer may be a general-purpose computer, a special-purpose computer, a computer network, or another programmable device. The computer instructions may be stored in a computer-readable storage medium, or transmitted from one computer-readable storage medium to another computer-readable storage medium. For example, the computer instructions may be transmitted from a website, computer, server, or data center, to another website, computer, server or data center via wired (such as coaxial cable, optical fiber, digital subscriber line (DSL)) or wireless (such as infrared, wireless, microwave, etc.) manner. The computer-readable storage medium may be any available medium that can be accessed by a computer or a data storage device such as a server or data center integrated with one or more available media. The usable medium may be a magnetic medium (for example, a floppy disk, a hard disk, a magnetic tape), an optical medium (for example, a digital video disc (DVD)), or a semiconductor medium (for example, a solid state disk (SSD)), etc.

A person of ordinary skill in the art can be aware that the units and algorithm steps described in the embodiments disclosed herein can be implemented by electronic hardware, computer software, or a combination of both. To clearly illustrate the hardware and software interchangeability, in the above description, the composition and steps of each example have been generally described in accordance with the function. Whether these functions are executed by hardware or software depends on the specific application and design constraint conditions of the technical solution. Professionals and technicians can use different methods for each specific application to implement the described functions, but such implementation should not be considered beyond the scope of the present disclosure

Those skilled in the art can clearly understand that, for the convenience and conciseness of description, the specific working processes of the above-described system, device, and unit is not repeated, and reference can be made to the corresponding processes described in the foregoing method embodiments.

In the embodiments provided in the present disclosure, it should be understood that the disclosed system, device, and method may be implemented in other ways. For example, the device embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

When the integrated unit is implemented in the form of a software functional unit and sold or used as an independent product, it can be stored in a computer readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a U disk, a mobile hard disk, a read-only memory (ROM), a random access memory (RAM), a magnetic disk, an optical disk, or another medium that can store program codes.

The above are only specific implementations of embodiments of the present disclosure, but the scope of the present disclosure is not limited to this. Anyone familiar with the technical field can easily think of various equivalents within the technical scope disclosed in the present disclosure. These modifications or replacements shall be covered within the scope of the present disclosure. Therefore, the protection scope of the present disclosure shall be subject to the protection scope of the claims.

What is claimed is:

1. A point cloud attribute encoding method comprising:
performing binarization on an attribute value in point cloud data to obtain a binary attribute value, a bit depth of the binary attribute value being larger than or equal to 1; and
performing arithmetic encoding on bits in the binary attribute value using at least one probability model.

2. The method according to claim 1, wherein performing arithmetic encoding on the bits in the binary attribute value using the at least one probability model includes performing arithmetic encoding on different ones of the bits in the binary attribute value using at least two probability models.

3. The method according to claim 1,
wherein the attribute value is one of a plurality of attribute values in the point cloud data;
the method further comprising:
performing binarization on the plurality of attribute values to obtain a plurality of binary attribute values; and
performing arithmetic encoding on same bits in different ones of the binary attribute values using a same probability model.

4. The method according to claim 1, wherein performing arithmetic encoding on the bits in the binary attribute value includes performing arithmetic encoding on at least two lowest bits in the binary attribute value using a same probability model.

5. The method according to claim 1, wherein performing arithmetic encoding on the bits in the binary attribute value includes performing arithmetic encoding on at least two highest bits in the binary attribute value using different probability models.

6. The method according to claim 1, wherein performing arithmetic encoding on the bits in the binary attribute value includes performing arithmetic encoding on different ones of the bits in the binary attribute value using different probability models.

7. The method according to claim 1, further comprising:
generating a code stream including encoding results of the arithmetic encoding.

8. The method according to claim 7, wherein:
header information of the code stream includes indication information; and
different values of the indication information indicate different encoding schemes.

9. The method according to claim 7, wherein:
header information of the code stream includes indication information; and
different values of the indication information indicate different types of the binary attribute value.

10. A point cloud attribute decoding method comprising:
performing arithmetic decoding on attribute information in a code stream using at least one probability model to obtain a binary attribute value; and
performing inverse binarization on the binary attribute value according to a binarization method corresponding to the binary attribute value to obtain an attribute value.

11. The method according to claim 10, wherein performing arithmetic decoding on the attribute information in the code stream includes performing arithmetic decoding on different bits in the code stream using at least two probability models.

12. The method according to claim 10, further comprising:
performing arithmetic decoding on same bits in different binary attribute values in the code stream.

13. The method according to claim 10, wherein performing arithmetic decoding on the attribute information in the code stream includes performing arithmetic decoding on at least two lowest bits in the binary attribute value using a same probability model.

14. The method according to claim 10, wherein performing arithmetic decoding on the attribute information in the code stream includes performing arithmetic decoding on at least two highest bits in the binary attribute value using different probability models.

15. The method according to claim 10, wherein performing arithmetic decoding on the attribute information in the code stream includes performing arithmetic decoding on different bits in the binary attribute value using different probability models.

16. The method according to claim 10, further comprising:
receiving the code stream including the attribute information.

17. The method according to claim 16, wherein:
header information of the code stream includes indication information; and
different values of the indication information indicate different decoding schemes.

18. The method according to claim 16, wherein:
header information of the code stream includes indication information; and
different values of the second indication information indicate different types of the binary attribute value.

19. A point could attribute decoding device comprising:
a memory storing codes; and
a processor configured to execute the codes to:
perform arithmetic decoding on attribute information in a code stream using at least one probability model to obtain a binary attribute value; and
perform inverse binarization on the binary attribute value according to a binarization method corresponding to the binary attribute value to obtain an attribute value.

20. The device according to claim 19, wherein the processor is further configured to execute the codes to:
perform arithmetic decoding on different bits in the code stream using at least two probability models.
